(19) United States
(12) Patent Application Publication
(10) Pub. No.: US 2013/0204937 A1
(43) Pub. Date: Aug. 8, 2013

(54) PLATFORM FOR INFORMATION MANAGEMENT AND METHOD USING SAME

(71) Applicants: Barry Fernando, Phoenix, AZ (US); Mark C. Phelps, Tucson, AZ (US); David Hirschfeld, Scottsdale, AZ (US)

(72) Inventors: Barry Fernando, Phoenix, AZ (US); Mark C. Phelps, Tucson, AZ (US); David Hirschfeld, Scottsdale, AZ (US)

(21) Appl. No.: 13/603,258

(22) Filed: Sep. 4, 2012

Related U.S. Application Data
(60) Provisional application No. 61/530,912, filed on Sep. 2, 2011.

(51) Int. Cl. H04L 29/08

(52) U.S. Cl. CPC H04L 67/02
USPC 709/204

(57) ABSTRACT

A method to create a member account in a social network, comprising downloading an application programming interface from a social network server, creating a profile, creating a plurality of Identities associated with the profile, creating a different association for each Identity with one or more of a plurality of social network members and users such that all contact with a first social network member is made using exclusively a first Identity and such that all contact with a second social network member is made using exclusively a second Identity, wherein the first Identity differs from the second Identity, and uploading the profile, the plurality of Identities, and the associations of Identities, to the social network server.

### CROSS-REFERENCE TO RELATED APPLICATIONS

This Applications claims priority from a U.S. Provisional Application having Ser. No. 61/530,912 and filed Sep. 2, 2011. The U.S. Provisional Application having Ser. No. 61/530,912, and an Appendix filed therewith, are incorporated by reference herein.

### FIELD OF THE INVENTION

Embodiments generally relate to assemblies, methods, devices, and systems for managing information, and more particularly, to assemblies, methods, devices, and systems for receiving and storing multimedia information relevant to one or more Identities of a member and sharing the multimedia information with a user via a network.

### BACKGROUND OF THE INVENTION

Personal information management tools, such as organizers, have limited capabilities. For example, when the information in a contact list within a organizer is outdated, the owner of the contact list must try to reach the corresponding contact in order to obtain updated information and manually enter the updated information into the profile of the corresponding contact in the owner's contact list. Similarly, such information management tools provide little control on the format and content of the information that the owner would like communicated or not communicated to respective contacts of the owner. Having access to accurate information about others and the ability to communicate tailored information to others is valuable in the art of commerce.

Accordingly, it would be an advance in the art of commerce to provide solutions that can help facilitate updated and tailored communication between individuals.

### SUMMARY OF THE INVENTION

In certain embodiments, a member uses a computing device to send information for each of a plurality of Identities of the member for storage on a cloud via a network. The member requests that the information for a first Identity be transmitted to a contact.

In another embodiment, a computing device of a member and a computing device a contact each send corresponding location data to a computing device of a host within a system. The social network server uses the received location data to determine the location of each of the computing devices and sends the determined locations to the computing device of the member. The computing device of the member requests the social network server to exchange information fields with the computing device of the user within its proximity. The social network server sends a transmission to the computing device of the user requesting the user to exchange information fields with the member, wherein when the contact is one of the members in the system, the request is for the name of the contact. The social network server receives a response from the computing device of the contact which is, in turn, sent to the computing device of the member.

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates an exemplary embodiment of a system for information management;

FIG. 2 illustrates another exemplary embodiment of a system for information management;

FIG. 3A is a table of information fields stored in association with each of a plurality of Identities of a member;

FIG. 3B-3D are each a schematic showing data flow between a member and users within a system for information management;

FIG. 4 is a schematic showing exemplary modules encoded in computer readable mediums within the system(s) of FIGS. 1 and/or 2; and

FIG. 5 summarizes methods and/or processes related to data management.

### DETAILED DESCRIPTION OF PREFERRED EMBODIMENTS

The invention is described in preferred embodiments in the following description with reference to the FIGs., in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” “in certain embodiments,” and similar language throughout this specification may, but do not necessarily, all refer to the same embodiment. It is noted that, as used in this description, the singular forms “a,” “an” and “the” include plural referents unless the context clearly dictates otherwise.

The described features, structures, or characteristics of the invention(s) may be combined in any suitable manner in one or more embodiments. In the following description, numerous specific details are recited to provide a thorough understanding of embodiments of the invention(s). One skilled in the relevant art will recognize, however, that the invention(s) may be practiced without one or more of the specific details, or with other methods, components, materials, and an forth. In other instances, well-known structures, materials, or operations are not shown or described in detail to avoid obscuring aspects of the invention.

In certain embodiments, a platform for data management is implemented on a network. A member uses a computing device to transmit information fields to a social network server, accessed via the network, to create multiple Identities, each with respective information about the member. The member selects a first Identity to send to a first user and a second Identity to send to a second user. In some embodiments, the first user is a contact of the member that the member had previously included in a contacts list of the member while the second user is a stranger to the member. The member, in turn, retains control over the information associated with each of the Identities that are communicated to the respective users. For example, in certain embodiments, the member updates the information for the first Identity, augments the information for the second Identity, or withdraws the second users' access to the information for the second Identity. The member has access to a plurality of modules to manage the information fields about the users, communicate media rich content with the users, locate users, manage a presence of the member on a plurality of social networking sites, and share libraries with users, for example.

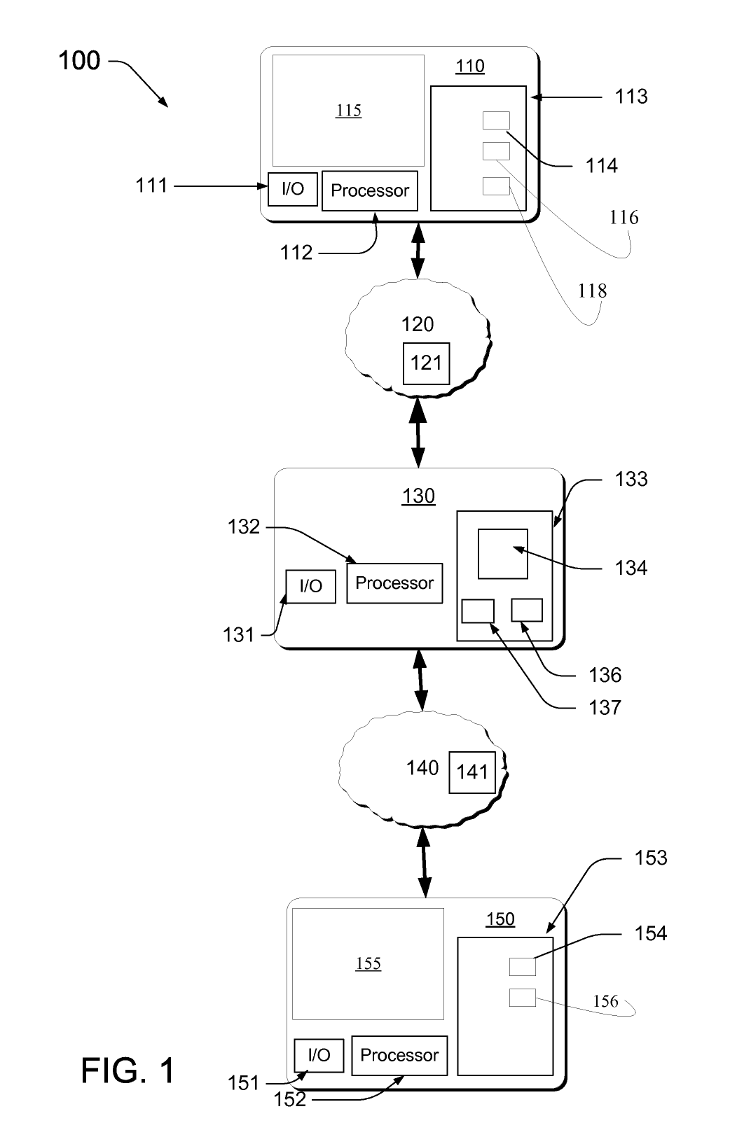

Referring to FIG. 1, a portion of Applicants' social network 100 is illustrated. In certain embodiments, Applicants' social network 100 is an open social network. In certain embodiments, Applicants' social network 100 is a closed social network.

In the illustrated embodiment of FIG. 1, social network 100 comprises asocial network server 130 that is communicatively connected to a computing device 110 through a first communication fabric 120 and a computing device 150 through a second communication fabric 140. In certain embodiments, the social network server 130 is owned and/or operated by a social networking service provider; and the computing device 150 is computing device that is owned and/or operated by a user of the social network 100; the computing device 110 is a computing device that is owned and/or operated by a member of the social network 100, wherein a member is a user that has a profile containing information about the member stored in a information 137 of the social network server 130. In some embodiments, the computing device 110 is owned and operated by a first member and the computing device 150 is owned and operated by a second member.

For the sake of clarity, FIG. 1 shows a single computing device 110, social network server 130, and computing device 150. FIG. 1 should not be taken as limiting. Rather, in other embodiments any number of entities and corresponding devices can be part of the social network 100, and further, although FIG. 1 shows two communication fabrics 120 and 140, in other embodiments less or more than two communication fabrics is provided in the social network 100. For example, in certain embodiments, the communication fabric 120 and the communication fabric 140 are the same communication fabric.

In certain embodiments, the computing devices 110, 130, and 150 are each an article of manufacture. Examples of the article of manufacture include: a server, a mainframe computer, a mobile telephone, a smart telephone, a personal digital assistant, a personal computer, a laptop, a set-top box, an MP3 player, an email enabled device, a tablet computer, a web enabled device, or other special purpose computer each having one or more processors (e.g., a Central Processing Unit, a Graphical Processing Unit, or a microprocessor) that is configured to execute Applicants' API to receive information fields, transmit information fields, store information fields, or performing methods.

By way of illustration and not limitation, FIG. 1 illustrates the computing device 110, the social network server 130, and the computing device 150 as each including a processor 112, 132, and 152, respectively, a non-transitory computer readable medium 113, 133, and 153, respectively, having a series of instructions, such as computer readable program steps encoded therein; an input/output means 111, 131, and 151, respectively, such as a keyboard, a mouse, a stylus, touch screen, a camera, a scanner, or a printer. Computer readable program code 114, 134, and 154, respectively, is encoded in non-transitory computer readable media 113, 133, and 153, respectively. Processors 112, 132, and 152, respectively utilize computer readable program code 114, 134, and 154, respectively, to operate computing devices 110, 130, and 150, respectively. In certain embodiments, the computing device 110, 130, and 150 employ hardware and/or software that supports accelerometers, gyroscopes, magnetometers (e.g., solid state compasses) and the like.

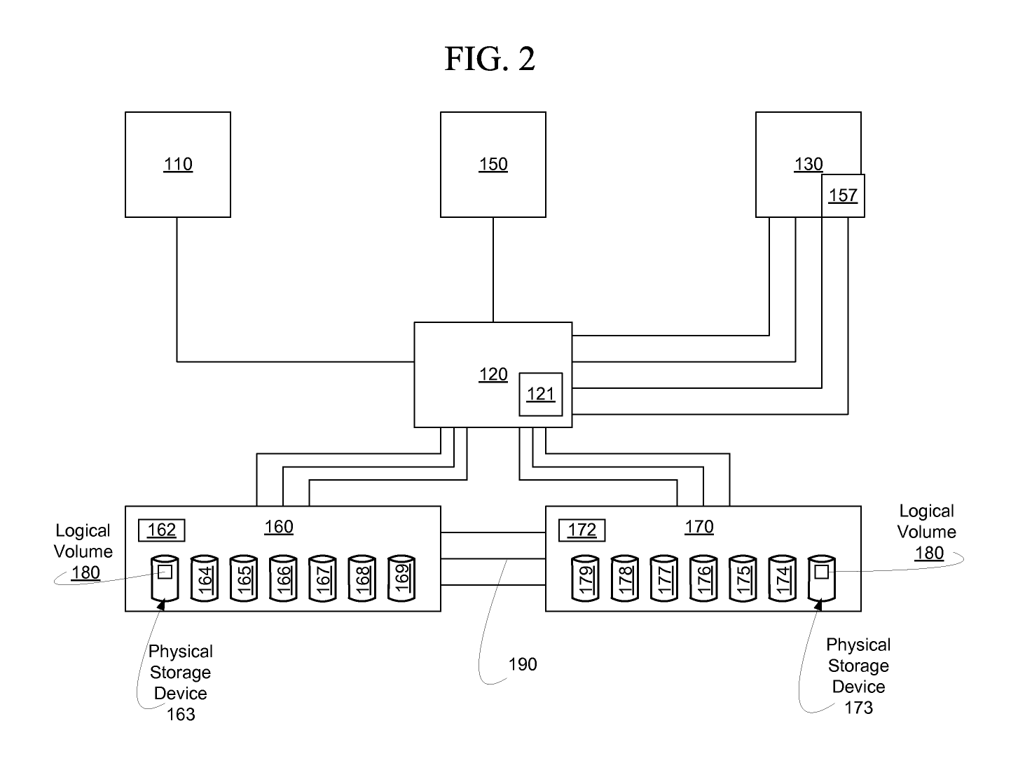

Processors 112 and 152 access Application Program Interfaces (APIs) 116 and 156, respectively, encoded in computer readable media 113 and 153, respectively, to communicate with host 130 and access Applicants' algorithm 136 encoded in computer readable medium 133 to implement Applicants' social network and method described herein. Algorithm 136 comprises Applicants' source code to operate a public or private social network, and when implemented by computing device 110 causes a graphic user interface (“GUI”) to be displayed on display screen 115, wherein that GUI comprises and displays a plurality of graphical interactable objects. A member using computing device 110 can utilize that GUI to access a logical volume, such as for example and without limitation logical volume 180 (FIG. 2), wherein information and Identities specific to that user are encoded in logical volume 180. The user can utilize the GUI to access Applicants' social network as described herein.

The following Examples are presented to further illustrate to persons skilled in the art how to make and use the invention. These Examples are not intended as limitations, however, upon the scope of the invention.

### Example I

Applicants' algorithm 136, and its functions, can be utilized by other applications by accessing Applicants' API 116/156. Using Applicants' API allows other users and/or applications to implement the social networking capabilities of Applicants' algorithm 136 thereby eliminating the need for these other users and/or applications to develop their own internal social networking capabilities. For example, AnzuMedical, a software platform created for medical associations to publish digital content to their members, may utilize Applicants' algorithm 136 through Applicants' API, and thereby enable the medical associations users to share documents and engage in either private or group discussions within the AnzuMedical user community. As a general matter, use of Applicants' algorithm 136 and API 116/156 allow other users and/or applications, such as AnzuMedical, to configure public or private social networks germane to their user community. Applicants' algorithm 136 creates the ability for members to communicate and share to other users or to groups of other users through the use of created Identities. The ability to create private or public social networks using Applicants' algorithm 136 allows the option to implement Applicants' API in a private manner, so that the newly-created social network become private, e.g. hidden from other social network members and users that are not permitted access to the Identities of the private social network members.

### Example II

In certain embodiments, Applicants' algorithm 136 implements the ability to share and discuss a specific time indexed point in a video file. In these embodiments, many separate social network exchanges may simultaneously exist for a single video file, each exchange associated with a specific time-indexed point in the video file. This capability differs is markedly from prior art methods wherein social exchanges are limited to video file as a whole. By “social exchange,” Applicants mean any type of chat, discussion, forum, voting/rating, and the like.

Processor 132 accesses the computer readable program code 134, encoded on the non-transitory computer readable medium 133, and executes an instruction 136 to electronically communicate with the computing device 110 via the communication fabric 120 or electronically communicate with the computing device 150 via the communication fabric 140. Encoded information 137 is maintained of the data communicated or information fields communicated, e.g., date and time of transmission, frequency of transmission. and the like, with any or all of the computing device 110 and the computing device 150. In certain embodiments, information 137 is analyzed and/or mined. In certain embodiments, information 137 is encoded in a plurality of individual logical volumes specific to each member/user.

In certain embodiments, computing devices 110 and 150 further comprise one or more display screens 115 and 155, respectively. In certain embodiments, display screens 115 and 155 comprise an LED display device.

In certain embodiments, the information fields received from the computing device 110 at the social network server 130 is exchanged with other computing devices not shown in FIG. 1. For example, information fields received from a social network in which the member has an Internet presence is sent to the social network server 130 and stored at the information 137 in association with a profile of the member. Alternatively, or in combination, the information fields transmitted from the computing device 110 to the social network server 130 is sent to an account of the member within the social network.

In certain embodiments, information 137 is encoded in one or more hard disk drives, tape cartridge libraries, optical disks, combinations thereof, and/or any suitable data storage medium, storing one or more databases, or the components thereof, in a single location or in multiple locations, or as an array such as a Direct Access Storage Device (DASD), redundant array of independent disks (RAID), virtualization device, . . . etc. In certain embodiments, information 137 is structured by a database model, such as a relational model, a hierarchical model, a network model, an entity-relationship model, an object-oriented model, or a combination thereof. For example, in certain embodiments, the information 137 is structured in a relational model that stores a plurality of Identities for each of a plurality of member as attributes in a matrix.

In certain embodiments, the computing devices 110, 130, and 150 include wired and/or wireless communication devices which employ various communication protocols including near field (e.g., “Blue Tooth”) and/or far field communication capabilities (e.g., satellite communication or communication to cell sites of a cellular network) that support any number of services such as: telephony, Short Message Service (SMS) for text messaging, Multimedia Messaging Service (MMS) for transfer of photographs and videos, electronic mail (email) access, or Global Positioning System (GPS) service, for example.

As illustrated in FIG., the communication fabrics 120 and 140 each comprise one or more switches 121 and 141, respectively. In certain embodiments, communication fabrics 120 and 140 are the same. In certain embodiments, at least one of the communication fabrics 120 and 140 comprises the Internet, an intranet, an extranet, a storage area network (SAN), a wide area network (WAN), a local area network (LAN), a virtual private network, a satellite communications network, an interactive television network, or any combination of the foregoing. In certain embodiments, at least one of the communication fabrics 120 and 140 contains either or both wired or wireless connections for the transmission of signals including electrical connections, magnetic connections, or a combination thereof. Examples of these types of connections include: radio frequency connections, optical connections, telephone links, a Digital Subscriber Line, or a cable link. Moreover, communication fabrics 120 and 140 utilize any of a variety of communication protocols, such as Transmission Control Protocol/Internet Protocol (TCP/IP), for example.

Referring to FIG. 2, the computing devices 110, 130 and 150 are each communicatively connected to the communication fabric 120, such as a WAN or Internet. The social network server 130 is a computing device that is owned and/or operated by a social networking service provider; and the computing device 150 is a computing device that is owned and/or operated by a user; the computing device 110 is a computing device that is owned and/or operated by a member of the system. In certain embodiments, the social network server 130 provides access to the computing devices 110 and 150 to execute Applicants' source code 136 via a Software as a Service (SaaS) means.

In certain embodiments information fields is received from one or more computing devices 110, 130 and/or 150 and stored on the “Cloud” such as data storage library 160 and/or 170. Each of the data storage libraries 160 and 170 have corresponding physical storage devices, such as and without limitation physical data storage devices 163-169 for datastorage library 160; and 173-179 for data storage library 170.

In certain embodiments, data storage library 160 and data storage library 170 are configured in a Peer To Peer Remote Copy (“PPRC”) storage system, wherein the information fields in data storage library 160 is automatically backed up in data storage library 170. In certain embodiments, Applicants' PPRC storage system utilizes synchronous copying. In certain embodiments, Applicants' PPRC storage system utilizes asynchronous copying.

In the illustrated embodiment of FIG. 2, physical storage device 163 is configured to comprise logical volume 180. In certain embodiments, each physical storage device in data storage library 160 is configured to comprise a plurality of logical volumes. Similarly, each physical storage device in data storage library 170 is configured to comprise a corresponding plurality of logical volumes. In certain embodiments, each member of the social network is assigned a unique logical volume. A Permissions File is encoded in one or more of modules 157, 162, and/or 172. In certain embodiments, Permissions File 157 is encoded in computer readable medium 133. Permissions File 157, 162, and/or 172 associates each logical volume with a social network member, and further associates each logical volume with access permissions for certain designated other social network users. Each social network user configures his/her own logical volume permissions. If a first user desires to remove access permissions from a second user, that first member simply accesses his/her permissions file and deletes the second user. Thereafter, the second user cannot retrieve current contact or location data for the first user.

Referring to FIGS. 1, 2 and 3A-3D, a schematic illustrates a data flow for the exchange of profile information fields between a member and several users within the systems of FIGS. 1 and 2. A member utilizes the computing device 110 to access the social network server 130, such as by using a browser to access a website social network server or downloading an application that includes an API, such as API 116 (FIG. 1) for communicating with the social network server 130. The member then utilizes the computing device 110 to create a member account 330 within the social network 100 by, for example, sending a request to the social network server 130 to open the account. The member then creates a member profile by providing information fields associated with the member to the social network server 130.

To illustrate, Jones uses the computing device 110 to communicate with the social network server 130 to download an application 118 and API 116 that is configured to communicate with the social network server 130. The downloaded application 118 is, in turn, stored on the non-transitory computer readable medium 113 of the computing device 110. Jones uses the downloaded application 118 to create a member account and a profile 310 within the system 110.

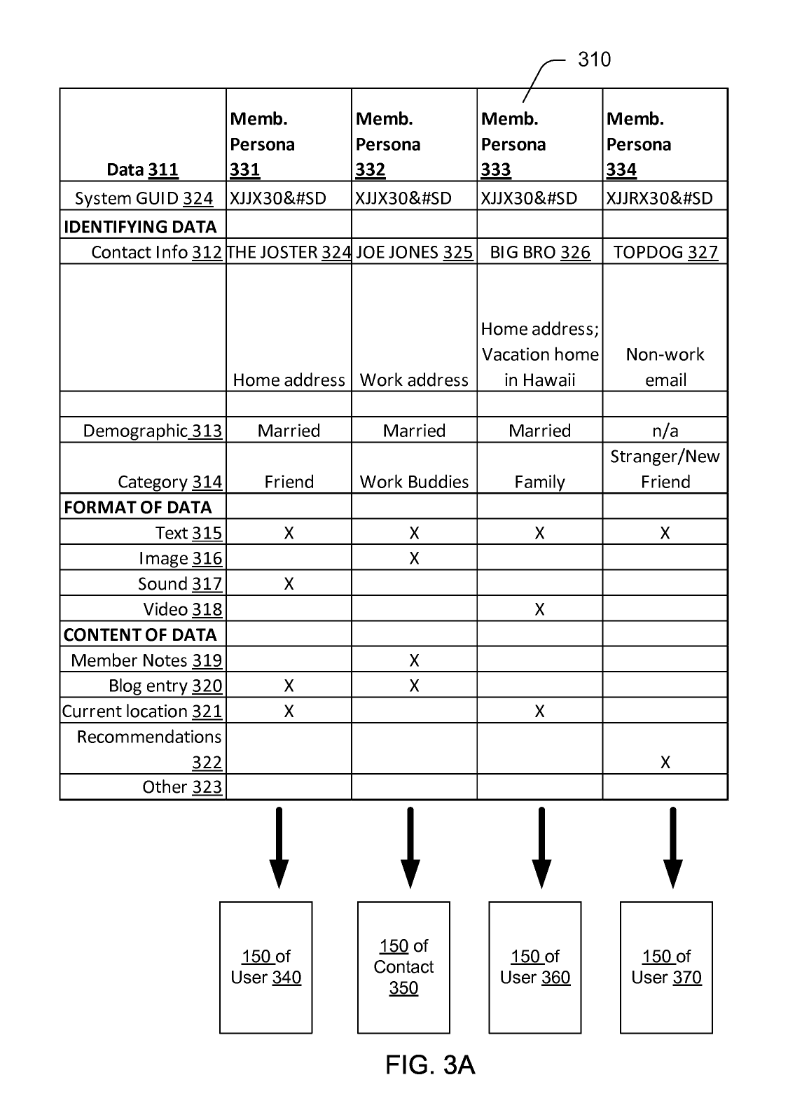

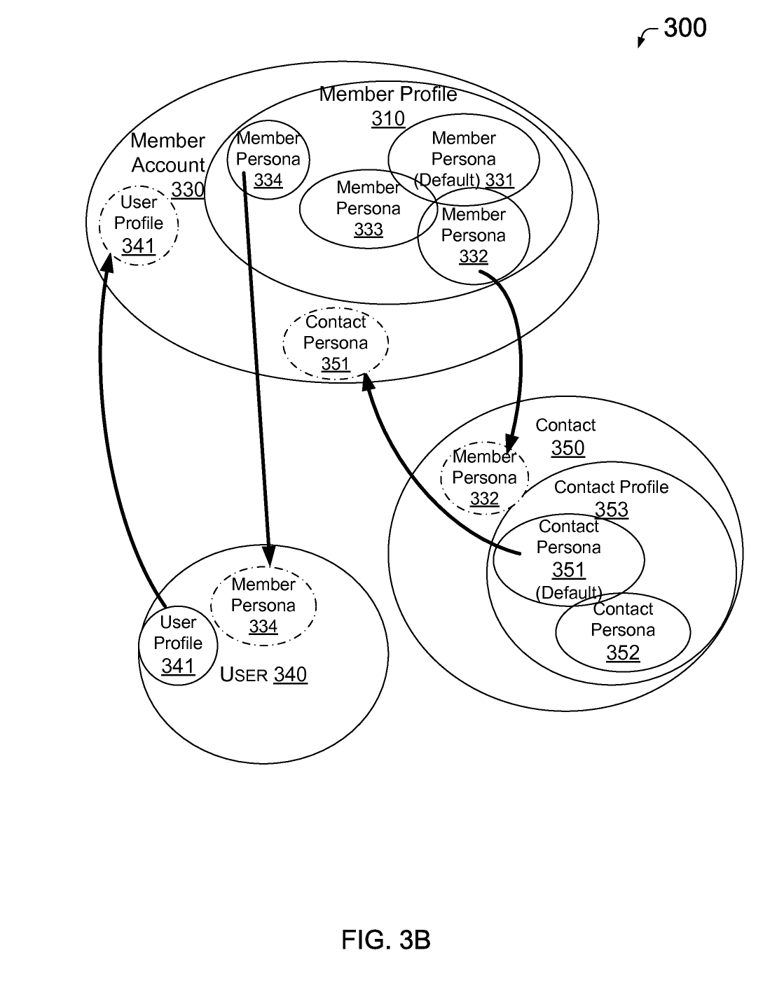

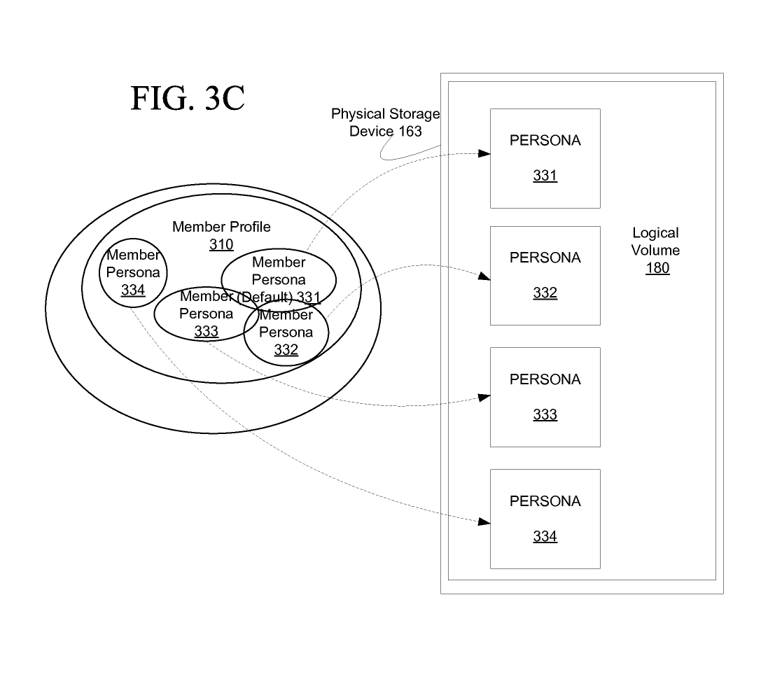

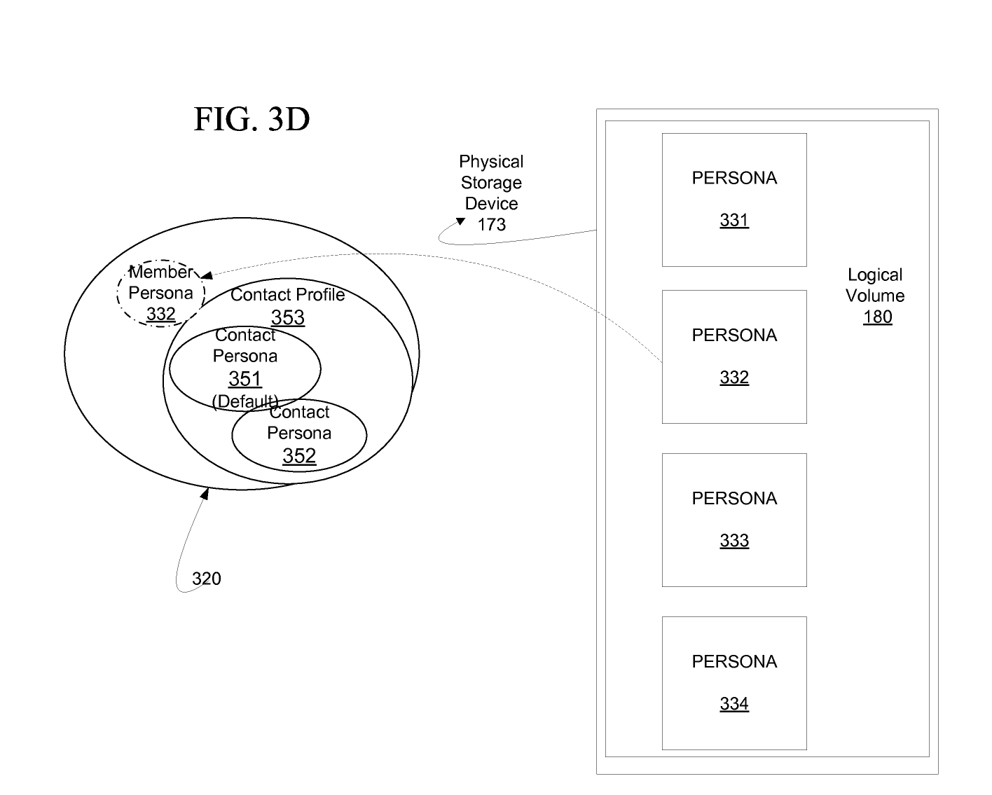

Referring to FIGS. 1 and 3A, Jones creates a profile by sending the information fields 311 associated with Jones to the social network server 130, which is, in turn, stored in log 137. The member profile 310 includes information fields 311 about the member, such as the contact information 312 of the member (e.g., member's name, the members address, the members phone number, or the members e-mail address) and/or preferences of the member associated with each Identity of the member, such as a preference for a format of information fields or a type of content that is to be associated with each of a plurality of created Identities of the member from a selection of a plurality of media formats.

In the example of FIG. 3A, the information fields is illustrated to include text 315, image 316, sound 317, and video 318 formats; other formats are also contemplated, such as holographic formats and combinations thereof. In certain embodiments, the profile of the member includes multimedia data formats. For example, the member uploads videos, images (e.g., pictures, maps, schematics), audio files, textual documents (e.g., family newsletter; see Appendix page 42), or enters a textual link to websites of interest to the member into the profile of the member, which is categorized and/or associated with various Identities (see Appendix pages 7 exemplary profile multimedia data). In the example of FIG. 3A, the member profile 310 further includes demographic 313 data, category 314 data, blog entry 320 data, current location 321 data and recommendations 322 data (e.g., preferences or rating of the member for identified goods or services), for example. Other 323 information fields is also contemplated, such as information about other people or friends (e.g., name of children).

The member uses the computing device 110 to select portions and/or define formats of the information fields 311 to include in each of a plurality of Identities of the member, which is tailored for a set of users. In certain embodiments, the member selects a portion of the information fields in the profile to associate with one or more Identities (see Appendix pages 9-10 exemplary selection of portions of the information fields in the profile for Identity Tekyz, indicated via check marks).

In the example of FIG. 3A, the member has four member Identities: Identity 331, Identity 332, Identity 333, and Identity 334. Identity 331 is an Identity that the member shares with friends, which includes text 315 and sound 317 formatted data. To illustrate, the Identity 331 includes the member's name and a blog entry of the member along with access to and access an MP3 formatted original song by the member and a real-time GPS location of the computing device 110 of the member. Identity 332 is a work Identity that the member shares with clients, which includes text 315 and image 316 formatted data. Identity 332 includes the member's name, a website address of the business of the member, images of the facility of the business of the member, notes about recent discounts at the business of the member, and a blog entry describing the latest cutting edge technology utilized at the business of the member, for example. Identity 333 is an Identity of the member that the member shares with family members, which includes text 315 and video 317 formatted data. Identity 333 includes the member's name and access to a video of a family vacation of the member, and a real-time GPS location of the computing device 110 of the member, for example. Identity 334 is an Identity of the member that the member shares with strangers, which includes text 315 formatted data. Identity 334 includes only the opinions of the member regarding specific goods or services of others. Consequently, the member has the ability to tailor information sent to various groups of users.

Using Applicants' apparatus and method, when a user taps a contact from a displayed Contact List, details about that contact are displayed, including which Identity is provided to that contact. Non-favorite contacts appear with a blue star icon while favorite contacts appear with a yellow star icon. The user can tap an Add Note icon to add a note about the contact. In addition, the user can elect to block this contact whereby the contact no longer has access to the user's Identity or contact information.

In addition, a user can elect to change the Identity shared with a contact. Moreover, a user can elect at any time to create a new Identity. Such a new identity can be made either Shareable or Default. If a newly-created Identity already exists for the user, Applicant's apparatus and method displays an error message to that effect. If the new Identity did not previously exist, then the new Identity is created and is displayed in the user's Identity list.

A user may edit an Identity name while keeping the information about that Identity the same. In addition, a user may delete an Identity as long as the user has created more than one Identity.

A user may change the privacy property for an Identity. An Identity may be designated Shareable or Non-Shareable. If an Identity is made Shareable, then contacts holding the user's shareable Identity may forward that Identity to others. In certain embodiments, unchecking a Shareable radio button for an Identity makes that Identity non-shareable.

In certain embodiments, a user may view a listing of Identity's that include a selected information field. In certain embodiments, whenever a user adds anew information field, a privacy property for that new field is designated Private.

Applicant's apparatus and method generate three standard Sections, including Contact, Map, and Notes. These three Sections cannot be deleted.

A user can create new Sections, or other than the three standard Sections delete Sections. Such Sections may include, without limitation, About Me, Library, My Content, Social, Products, Corp View, Comm List, Real Estate, and the like. In certain embodiments, as many as twelve (12) Section icons can be displayed simultaneously. A user can designate any newly-created Section as Public, Private, or Person-Based.

In certain embodiments, the social network server 130 assigns a Global Unique IDentifier (GUID) 324 to the member and associates the GUID 324 with the information fields in the profile 310 of the member. In the illustrated embodiment of FIG. 3A, the GUM 324 is stored at the information 137 in association with each of the Identities of the member Jones.

The social network server 130 creates or selects the GUID. In certain embodiments, the social network server 130 uses a pseudo-random alphanumeric generator to create the GUID. In yet another embodiment, the social network server 130 creates the GUM based on the profile information fields. For example, in FIG. 3A, the social network server 130 selects the GUID 324 by combining the member's initials “JJ,” age 30, and a city of residence initials of San Diego to create the GUID “XJJX30&#SD.” Alternatively, or in combination, the GUID 324 is a predefined identifier or a combination of predefined identifiers of the member, such as a telephone number, social security number, or credit card number.

Once created or selected, the social network server 130, sends the GUID back to the computing device 110 of the member for inclusion in subsequent emails from the computing device 110 to the social network server 130. The social network server 130, in turn, uses the corresponding GUID 324 of the member to designate the member. For example, a transmission from the computing device 110 of the member includes the GUID 324 of the member Jones. When the social network server 130 receives the transmission, the social network server 130 compares the GUID 324 in the transmission with a plurality of GUIDs of respective members stored in the information 137 to find a match. When a match is found, the information fields stored in the information 137 in associated with the matched GUID is used to designate the corresponding member. To illustrate, if the social network server 130 receives a transmission with the GUID 324 “XJJX30L&#SD,” then the transmission is recognized to be from the member that is “The Joster” 324, “Jones” 325, “Big Bro” 326, and “Top Dog” 327.

Similarly, the social network server 130 includes the GUID of the member in transmissions from the member for delivery to computing devices 150 of respective users within the social network 100. For example, an initial transmission to the computing device 150 of the user that introduces the Identity (e.g., Identity 331) to the user includes the GUM of the member, such as GUID 324.

The computing devices 150 of the user, in turn, stores the GUID in association with Identity information fields in thee computing device 150 of the respective user. When subsequent transmissions including corresponding GUIDs are received, the computing device 150 compares the received GUID with the stored GUID to find a match.

For example, the member uses the computing device 110 to send a transmission to the computing device 150 of user 340, via the social network server 130. When social network server 130 of host receives the transmission from the computing device 110 of the member, the social network server 130 forms a transmission for delivery to the computing device 150 that includes the GUID 324 of the member. When the computing device 150 receives the transmission from the social network server 130, the computing device 150 compares the GUID 324 with other GUM stored in the computer readable medium 153 to find a match. When the match is found, the computing device 150 of user 340 recognizes the transmission as coming from “The Joster” 324.

Referring to FIG. 3B, the computing device 110 of the member accesses the social network server 130 to send Identity 332 to a computing device 150 of contact 350 that is already a contact within the member's contact list while also sending a second, different Identity 334 to the user 340 that is not in the contact list of the member. The social network server 130 sends the Identity 332 to the contact 350 while sending Identity 334 to user 340 that is not a contact.

In certain embodiments, referring to FIGS. 1 and 3A, the computing device 150 of the user stores the data associated with the respective Identity. Even if the computing device 150 is not in communication with the other computing devices in social network 100, the data associated with the Identity of the member is still accessible to the computing device 150. To illustrate, if the computing device 150 of user 340 is a smart phone and the connectivity of the smart phone is turned off, such as while the user is traveling on an airplane, the user 340 still has access to the contact information 312 for Identity 334.

Once received, the user can either accept or decline the Identity of the member. If accepted, the Identity of the member is included a contact directory of the user. The user may, but need not, send an Identity of the user back to the member in a reciprocal fashion. For example, the user receives Identity of the member but the user does not send profile information about the user (e.g., name, phone number, . . . etc.) back to the member that send the Identity. Alternatively, the user sends the profile information of the user back to the member. In FIG. 3B, the user 340 sends the user profile 341 back to the member and the contact 350 sends the Identity 351 of the contact back to the member.

When the member receives a profile of a user, the member, in turn, has the option to classify the profile of user in the contact list of the member. For example, the member classifies a user with a profile 341 as “basketball buddy” while Identity 351 of the contact 350 that works with the member is classified as “work acquaintance.” The categories are searchable such that the member is able to receive a list of all users that are categorized as “basketball buddy” in a corresponding search result, for example (see Appendix page 24).

In certain embodiments, the member utilizes the computing device 110 to send information fields associated with a plurality of Identities, to the Cloud. In FIG. 3C, the member utilizes the computing device 110 to the “Cloud” to send information fields associated with Identities 331, 332, 333, and 334 to the logical volume 180 of FIG. 2. For example, the member sends the contact information 312, a sound 317 file, a blog entry 320, and a current GPS location of the computing device 110 as part of the Identity 331 for storage in logical volume 180 which is one of a plurality of logical volumes configured on the physical storage device 163. In certain embodiments, the member then augments, updates, or deletes the information fields stored in the physical storage device 163. A second transmission is sent to the physical storage device 163 via the communication fabric 120 that is then stored in the logical volume 180, for example. In FIG. 3D, the information fields for specific Identities stored in the logical volume 180 is then transmitted to the social network server 130 of designated users according to the module 157, 162, and/or 172, for example.

In certain embodiments, the member uses the computing device 110 to augment the module 157, 162, and/or 172. The member using computing device 110 controls the level of access of another computing device, such as social network server 130, has to the information fields of the member stored on the social network server 130, data storage library 160 and/or data storage library 170, for example. To illustrate, the member sends a transmission including computer readable program code to withhold access authority to computing device 150 of an identified user to the member's information fields associated with Identity 332 stored in the data storage library 160. In this manner, even if computing device 150 requests the information fields associated with Identity 332, the computing device 150 will not receive the data denoted by dashed lines in FIG. 3D.

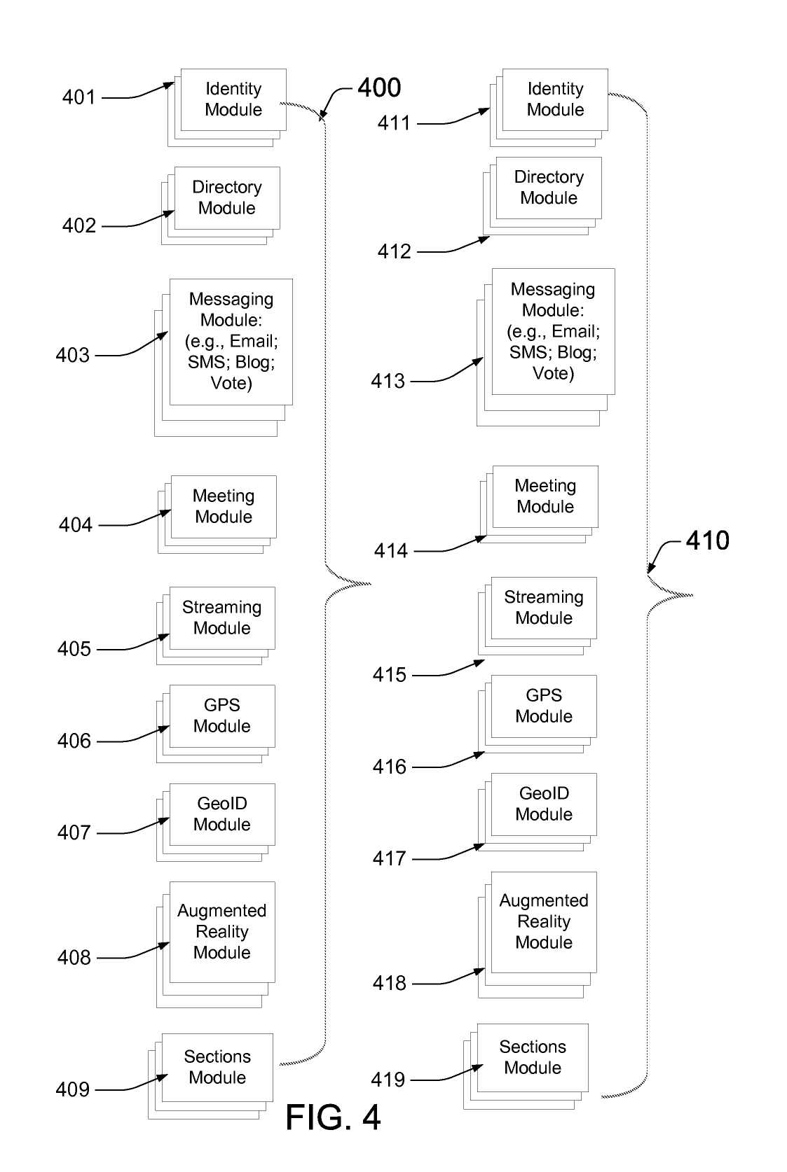

Referring to FIGS. 1 and 4, in some embodiments, at least one or more portions of the system of FIGS. 1 and/or 2 can be implemented as a software and/or hardware module that can be locally or remotely executed on one or more of the computing devices 110, 130, and 150. For example, one or more portions of the systems of FIGS. 1 and/or 2 include a hardware-based module (e.g., a digital signal processor (DSP), a field programmable gate array (FPGA)) and/or a software-based module (e.g., a module of computer code, a set of processor-readable instructions that can be executed at a processor). By way of example and not limitation, various modules are illustrated in FIG. 4. The modules are locally executable on one or more computing devices 110, 130, and/or 150. Other modules are also contemplated.

For example, the processor 112 (FIG. 1) executes the Identity Module 401 to create, modify, or delete information fields for any of a plurality of Identities for rendition on the computing device 110 and/or transmission to the social network server 130 via the communication fabric 120. The processor 132 of FIG. 1, in turn, executes the Identity Module 411 to: receive information fields for the Identity(s) from the computing device 110, store the information fields, access the information fields, modify the information fields, transmit all or portions of the information fields, or analyze the information fields, for example.

To illustrate, the member utilizes the computing device 110 to execute the Identity Module 401 to enter Identity1 data into a profile of the member and to classify one or more portions of the data that indicates the accessibility of the corresponding data for preselected users (see also Appendix pages 3-5). For example, the member categorizes a name of the member, “TOP DOG” 327 of FIG. 3A, as being freely shareable with all users (see also Appendix pages 3-5 open lock icon at left side of profile data) while the birth date of the member is categorized as not sharable via any Identities, rather, it is to be shared with a user only under the express permission of the member (see Appendix pages 3-5 closed lock icon at left side of profile data).

In certain embodiments, the processor 112 executes the Directory Module 402 of FIG. 4 to receive, create, modify, or delete contact data associated with each contact of the member for rendition on the computing device 110 and/or transmission to the social network server 130 via the communication fabric 120. The processor 132 executes the Directory Module 412 to: receive, store, access, modify, analyze, or transmit all or portions of the contact data, for example.

In certain embodiments, when executed, the Directory Module 402 and/or 412 obtains contact information of a plurality of contacts of the member and stores them in the computer readable medium 113 (FIG. 1). For example, when the Directory Module 402 and/or 412 is executed, a GUI is rendered on a display of the computing device 110 allowing the member to enter contact information of a first contact, to transfer contact information of a second contact, download contact information of a third contact from another computing device that is communicatively connected to the computing device 110, or a combination thereof, each of which is, in turn, stored in computer readable medium 113. Alternatively or in combination, when the Directory Module 402 and/or 412 is executed, the contact list of the member is automatically pre-populated. The computing device 110 automatically communicates with another computing device within a network to gather contact information. The Directory Module 402 automatically and intermittently logs onto an account of the member at a social networking site to obtain data from the site. For example, when executed, the user identification and password data of the member for a known social networking site is stored in computer readable medium 113. When the Directory module 402 and/or 412 is executed, such as preset intervals of time (e.g., every week), then the computing device 110 connects with a server of the social networking site via, automatically logging on using the member's identification and password, and synchronizing with a contact list of the member associated within the social networking site.

To illustrate, a member has a contact list of a plurality of contacts. The contact list is stored in the information 137 and/or computer readable medium 113 of FIG. 1. The contact list indicates which contacts: have an Identity of the member, have sent the member an Identity of the corresponding contact, or do not have an Identity of the contact (see Appendix page 13 arrow indicators on left side of contact list). Similarly, a corresponding indicator indicates if a contact does not have an Identity (e.g., the member does not have access to an Identity of the contact stored in the information 137 of FIG. 1).

In certain embodiments, the Directory Module 402 of FIG. 2 is executed to enters notes of the member relevant to a contact or group of contacts. For example, the member keeps track of messages, conversations, or activities shared between the member and a contact (see Appendix page 54-56). To illustrate, the member receives a text message from a contact “Smith” indicating that Smith's mother is in the hospital. The member, in turn, enters a note, “mother in the hospital,” in association with a profile of a contact, “Smith.” The next time the member sees Smith, the member checks the member's notes on Smith and follows up with Smith regarding the health of her mother. In certain embodiments, the Directory Module 402 and/or 412 of FIG. 4 is executed to set up an alert in association with a contact. In the above example, the member is able to set up a calendar reminder to alert to remind the member to call Smith and inquire about her mother.

In certain embodiments, the Directory Module 402 and/or 412 is executed to alter data associated with an Identity of the member. For example, the member has the ability to change the data associated with an Identity of the member that is then sent to computing devices 150 of users that previously received the Identity. Similarly, as previously stated, the member has the ability delete an Identity of the member from a computing device 150 of a user or to withdraw a specified user's access to an Identity. To illustrate, if member Jones is no longer friends with contact MacBeth, Jones remotely deletes Jones's Identity from MacBeth's contact list such that MacBeth no longer has access to Jones's Identity. To illustrate, Jones's computer device 110 sends instructions to the social network server 130 to withdraw MacBeth's access to Jones's Identity and to delete Jones's Identity from the computer readable medium 153 of computing device 150 of MacBeth.

In certain embodiments, the Messaging Module 403 is executed to receive, create, store, modify, or delete messages that are rendered on the computing device 110 of the member and/or form a transmission (e.g., email, SMS, blog entry, or vote) to one or more computing devices 150 of users via the communication fabrics 120 and 140. The Messaging Module 413 is, in turn, executable on the social network server 130 to: receive, store, access, modify, analyze, transmit all or portions of the messages of the member to one or more computing devices 150, for example.

In certain embodiments, the Messaging Modules 403 and/or 413 are executed to send data to, or request data from, a user (see Appendix page 14). For example, the member selects a contact from the contact list that does not have an Identity of the member. The member then composes a message for delivery to the computing device 150 of the selected contact, the message offering an Identity of the member to the selected contact. The delivery mode of the message is an email, an SMS message, a voice message to a phone number of the contact (see Appendix page 27), or an entry in a chat string within a social network of the member, for example.

In certain embodiments, the Messaging Modules 403 and/or 413 is executed to send an Identity in a mass mailing to a plurality of selected contacts from the contact list (see Appendix page 16 requesting a plurality of Identities from contacts). In one example, if the selected contact has a default Identity that is freely sharable, the default Identity is sent back to the computing device 110 of the member and stored in the information 137 in association with the contacts list of the member.

In certain embodiments, a hierarchy exists for the delivery mode of the message of the member to the user. The hierarchy is set based on preset business rules. For example, if the user that is to receive the message is also a member, a preset business rule dictates that the message be sent through a platform of the Messaging Module 403. Alternatively, if the user that is to receive the message is not a member, a preset business rule dictates that the message be sent as an email to an email address stored in association with the user in the information 137. The preset business rule would also dictate that if no email address is stored in association with the user in the information 137, the message is to be sent as a text message to a smart phone of the user, which smart phone's telephone number is stored in association with the user in the information 137. Other preset business rules for the delivery mode hierarchy of the message are also contemplated. For example, if the only address for the user that is to receive the message is a phone number of a telephone, then a phone call is made to the telephone and the message is relayed via telephony.

In certain embodiments, the messages include multimedia formatted data, which need not be in the same formats of data listed in the original Identity sent to the user. To illustrate, the computing device 110 of the member executes the Messaging Module 403 to compose a message to a contact in the contact list of the member (see Appendix page 34-35 message of member for delivery to contact), which received the Identity 332 of FIG. 3A, for example. The message includes multi-media formatted content (see Appendix page 38). For example, the message includes a text entry from the member to the contact (e.g., “meet you in 20 minutes”) and ureal-tine location of the member relative to the contact, which was a type of data that was not included in Identity 332 when the Identity 332 was originally sent to the contact. The computing device 150 of the contact, in turn, is able to utilizes the content in the message from the member to render a map showing the relative locations of the contact to the member and corresponding directions (see Appendix page 36-37).

In certain embodiments, the processor 112 executes the Messaging Module 403 to share interactive literature. The member shares annotated books, catalogs, journal articles, or music, for example, with one or more selected contacts within the contact list of the member. In one example, the contacts that received the interactive literature are selected individually or selected via a category (e.g., “basketball”) or selected via an Identity (e.g., all contacts having Identity “The Joster” 324).

In certain embodiments, the processor 132 executes the Messaging Module 413 to synchronize message entries with social networks in which the member has an Internet presence. For example, the member has an account with asocial network in which the member has chronological entries that are posted or sent to specified social networking accounts associated with the member. The Messaging Module 413 synchronizes the social networking account of the member such that the data from the social networking account is associated with Identities of the member according to predetermined business rules set up by the member (see Appendix pages 39). To illustrate, a wall associated with the Identity 333 of the member (FIG. 3A) includes all social networking accounts entries of the member that deal with the topic of “cars.” Similarly, the processor 132 executes the Messaging Module 413 to send data to the computing device hosting the social network, such as sending messages of the member dealing with “cars” to the social networking account of the member.

In certain embodiments, the processor 132 executes the Messaging Module 413 to render messages, organized via a topic, between a plurality of contacts and the member. For example, if the members and contacts have been sending messages to one another regarding an upcoming professional presentation, the group's messages are rendered on the computing device 110 in chronological order.

In certain embodiments, the processor 132 executes the Messaging Module 413 to survey opinions from a group of members and/or users. To illustrate, member Smith sends a “CEO” Identity to all partners of ACME Co. Smith then sends a message to all partners of ACME Co. having the CEO Identity inquiring whether ACME should acquire a current vendor of ACME Co. The computing devices 150 of the respective partners receive the message from Identity CEO and have the option to select buttons “10—Highly favor acquisition,” “8-favor acquisition,” “5-indifferent to acquisition,” “3—not favor acquisition,” or “1-highly disfavor acquisition.” The corresponding votes are each sent to the social network server 130. The social network server 130 then calculates statistics based on the votes (e.g., average of votes, variance between votes) and sends the results of the statistics to the computing device 110 of Smith.

In certain embodiments, a meeting module 404 and a meeting module 414 enable the member to conduct meetings with users, such as providing the member access to a forum for a secure audiovisual interaction, with selected contacts; a Streaming Module 405. A Streaming Module 415 enables the member to stream data over the cloud, such as broadcasting topical presentations or streaming blog entries. A Global Positioning System (GPS) module 406 and a GPS module 416 enable the computing devices 110, 130, and/or 150 to provide, transmit, and analyze location and time data of the computing devices 110, and/or 150, for example.

In some embodiments, a GeoID Module 407 and a GeoID Module 417 enable the member to receive an identifier (e.g., name) of a user, such as a stranger not in the contact list of the member, that is located within a defined geographical region, such as within proximity and/or in an identified direction relative to the computing device 110 of the member. The computing device 110 and 150 of the member and user, respectively, send data to the social network server 130. The data includes corresponding GPS location data, time data, data sufficient to identify the member or user associated with the corresponding computing device, and optionally magnetometer directional data.

In certain embodiments, the data sufficient to identify the member is the GUID of the member and the data sufficient to identify the user is the profile of the user or a default Identity of the user. The computing device 110 of the member receives a name of user that is located in the vicinity of the member. A user defines a business rule that a default Identity is freely sharable within the social network 100. The default Identity of the user has the name of the user. The member sees the user within his vicinity and has the processor 112 execute the GeoID module 407 to request the name of the user from the social network server 130.

The host GeoID module 417 enables the social network server 130 to distinguish members and/or users that are located within a defined geographic region using the received respective GPS location data and to, when queried, notify the member of the location or identify of the user within the proximity of the member. The social network server 130 compares the location data of the respective computing devices to find members and users that are in a geographic region, such as within proximity to one another.

To illustrate, member Jones is standing at the corner of Central Avenue and Jefferson Street in Phoenix, Ariz. Jones sees a person across the street that Jones believes he has met at a professional conference two years ago but Jones does not remember the name of the person. Jones points the computing device 110 towards the person across the street and uses the GeoID module 407 of computing device 110 to send a request for the person's Identity to the social network server 130. The GeoID Module 407 forms a transmission for delivery to the social network server 130, the transmission including the request, data sufficient to determine the GPS location of computing device 110, and data from the magnetometer of the computing device 110 sufficient to determine a direction that the computing device 110 is pointing. The host social network server 130 executes the GeoID Module 417 to compare the GPS location of the computing device 110 of Jones with the GPS location of a plurality of users to find users that are in the same geographic region as Jones, such as within 30 yards from Jones.

In the above example, the social network server 130 finds three users that are within 30 yards of Jones: Thompson, one of Jones contacts; Rogers, a contact of Jones and a member of the social network 100; and Othello a user that is not a contact of Jones. Using the magnetometer data, the computing device 110 determines that the computing device 110 is pointing North, which is in the direction of Othello relative to the location of Jones. The social network server 130, in turn, forms a transmission for delivery to the computing device 110 of Jones indicating that the person across the street is Othello.

In some embodiments, Augmented Reality modules 408 and 418 enable the computing device 110 of the member to alter a rendition of a real-time geographical region (e.g., an image) within the vicinity of the computing device 110 to include a computer generated sensory input, such as a sound, graphics, or text. For example, a camera of the computing device 110 captures a real-time images of a geographical region in the vicinity of the member, which is rendered on the computing device 110. The image of the real-time, proximate geographical region is then augmented with data stored in the computer readable medium 113 and/or 133, for example. To illustrate, if member uses the computing device 110 to capture a video of Niagara Falls, the rendered image also includes facts about Niagara Falls that is stored in the information 137, which is overlaid on the image of Niagara Falls. If a restaurant is located within the real-time, proximate geographical region, the name of the restaurant is listed in association with the image of the restaurant captured by the camera.

Sections Modules 409 and 419 enable the computing device 110 of the member to group identified data that is specific for a particular target impression and automatically sends the grouped data to identified recipients. In certain embodiments, the Sections Modules 409 and/or 419 are predetermined, in other embodiments, the member creates his own Sections. Examples of Sections include: a Social Media Aggregator Section, a Library Sections, and Company Section.

In certain embodiments, the Social Media Aggregator Sections provide a platform for the member to enter content that is then auto-populated to preselected social networking accounts (SN) of the member. For example, member Jones has a first SN account with a first SN service provider, a second SN account with a second SN service provider and member Jones frequently provides blog content to a public website. The Social Media Aggregator Section allows Jones to identify the first and second SN accounts; and the public website as recipients of selected data, such as content that the member has entered via a user interface rendered by the Social Media Aggregator Section. To illustrate, Jones provides a text entry “Out shopping at the local electronics store, a new Tablet is out! It has a fantastic new feature that allows for holographic projections of images” at a query box rendered by the Social Media Aggregator Section. The Social Media Aggregator Section sends the text entry to the social network server 130, which in turn, executes the Social Media. Aggregator Sections Modules 419 to automatically push the text entry to each of the first and second SN accounts; and the public website.

In certain embodiments, the Social Media Aggregator Section provides a platform for a member to access entries of a contact to each of plurality of SN accounts of a contact. The processor 112 of the computing device 110 executes the Social Media Aggregator Section to send, to the host social network server 130, data about one or more of a contact's SN accounts (e.g., an Internet Protocol address that leads to a profile of the contact's SN account). The social network server 130, in turn stores, at the information 137, the data about the one or more of a contact's SN accounts in association with the contact of the member. The social network server 130 uses respective API's to communicate with servers that operate each of the SN service providers to receive respective entries of the contact and to post responses of the member to same.

To illustrate, member Jones has a contact Larson in his contact list. Larson has as a first SN account with a first SN service provider and a second SN account with a second SN service provider. Jones uses the computing device 110 to execute Social Media Aggregator Section to send sufficient data about Larson's two SN accounts to the social network server 130. The processor 132 of the social network server 130 executes the Social Media Aggregator Section to communicate with each of the first and second SN service providers (e.g., via respective API's) to receive copies of Larson's entries in corresponding SN accounts. The computing device 110, in turn, sends Larson's entries to both her first and second SN accounts to the Jones' computing device 110 that renders the entries via a single messaging user interface. For example, Larson's entries to each of the first and second SN accounts are displayed on Jones' computing device 110 in chronological succession based on postage date and time. Jones, in turn, responds to one or more of the entries, which are then posted to respective social networking accounts of Larson. In certain embodiments, Jones' responses are posted to respective SN accounts of Larson from Jones' corresponding accounts hosted by the same SN service provider.

Similarly, in certain embodiments, the Messaging Aggregator Section provides a platform for a member to access entries of a contact to each of plurality of messaging accounts (e.g., email account, client-server voice over Internet Protocol account, peer-to-peer voice over Internet Protocol account, file transfer account, instant messaging account,), of the contact. The processor 112 of the computing device 110 executes the Media Aggregator Section to send to the host social network server 130 data about one or more of the member's messaging accounts and one or more of a contact's messaging accounts. The social network server 130, in turn, executes the Messaging Aggregator Sections Module 419 to store, at the information 137, the data about one or more of the member's messaging accounts in association with the member and the data about one or more of a contact's messaging accounts in association with the contact of the member. The social network server 130 uses respective API's to communicate with servers that operate each of the corresponding messaging service providers to receive respective entries and to send corresponding entries.

In certain embodiments, a member's response to a contact's message is sent from the member's account that is operated by the same messaging service provider that operates the contact's account. To illustrate, Jones' contact Larson sends an SMS message to Jones' SMS account and an email to Jones' email account. The social network server 130 executes the Messaging Aggregator Sections Module 419 to periodically check Jones Jones' SMS and email accounts, each having known addresses. The social network server 130 compiles the messages and sends them to the computing device 110 of the member for rendition, via a user interface, on the display of the computing device 110. The processor 112 of Jones' computing device 110 executes the Messaging Aggregator Section to render the user interface including Larson's SMS and email messages. Jones enters a response to each of the SMS and email messages from Larson by entering text in a query box of the user interface, which is sent to the host social network server 130. The social network server 130 receives Jones' response to the Larson's SMS message and email message. The processor 132 of the social network server 130, in turn, sends the Jones' response to Larson's SMS message to Jones' SMS account for forwarding to Larson's SMS account. Similarly, the processor 132 of the social network server 130 sends Jones' response to Larson's email to Jones' email account for forwarding to Larson's email account.

The Library Sections module groups the respective storage addresses for multimedia content of the member to create a library of books, novels, music, videos, pictures, drawings, works of art, or combinations thereof for example. The storage address may be for a location of the data stored in computer readable medium 113, the information 137, or a data repository of another computing device, such as a computing device on the cloud that is communicatively connected with the social network 100. The member, in turn, preselects contacts that are allowed access to the library. For example, the member preselects contacts that have an identified Identity of the member to have access to the library. Alternatively, or in combination, the member preselects identified contacts from the member's contact list which gives access to the library. In certain embodiments, the contacts are given access to the library, or portions thereof, for a fee.

Company Sections module provides a platform for the member to push data about a company to preselected recipients, such as contacts or identified websites. For example, the member is a Chief Executive Officer of ACME Co. The ACME Co. website posts information about the latest products and services on the ACME Co. website and includes an RSS (Really Simple Syndication) feed. The Company Sections module is set to automatically receive the RSS feed from the ACME Co. website and to push that information to the preselected contact and to syndicate the content with the identified websites. In certain embodiments, the Company Section automatically pulls data from the ACME Co. website without the need of an RSS feed.

Other modules are also contemplated (see Appendix page 48). For example, a calendar module enables the computing device 110 to maintain a calendar and related calendared events; and a task module enables the computing device 110 to maintain a running task list for the member.

In certain embodiments, one or more of modules 400/410 are executed together, in a serial and/or parallel fashion to produce a result. To illustrate, the processer 112 executes the Streaming Module 405, GPS Module 406, the GeoID Module 407, and the Augmented Reality Module 408 to render a real-time image of a geographic region that includes an overlaid text indicating a name of a user located within the geographic region. The GPS module 406 provides the GPS location of the computing device 110 of the member to the social network server 130. The streaming module 405 streams data received from a camera of the computing device 110 of the member to the social network server 130. The social network server 130, in turn, executes the streaming module 415 to receive and analyze the data from the camera. The social network server 130 executes the GPS module 416 to receive the GPS location of the computing device 110 of the member and the computing device 150 of the user, which sends its own GPS location to the social network server 130 via the communication fabric 140. The social network server 130 executes the GeoID module 417 to determine the relative location of the computing device 110 of the member to the computing device 150 of the user in the geographic region depicted by the camera. The computing device 110 executes the augmented reality module 418 to overlay the name of the contact onto the image of the geographic region captured by the camera. The overlaid image is sent to the computing device 110 of the member.

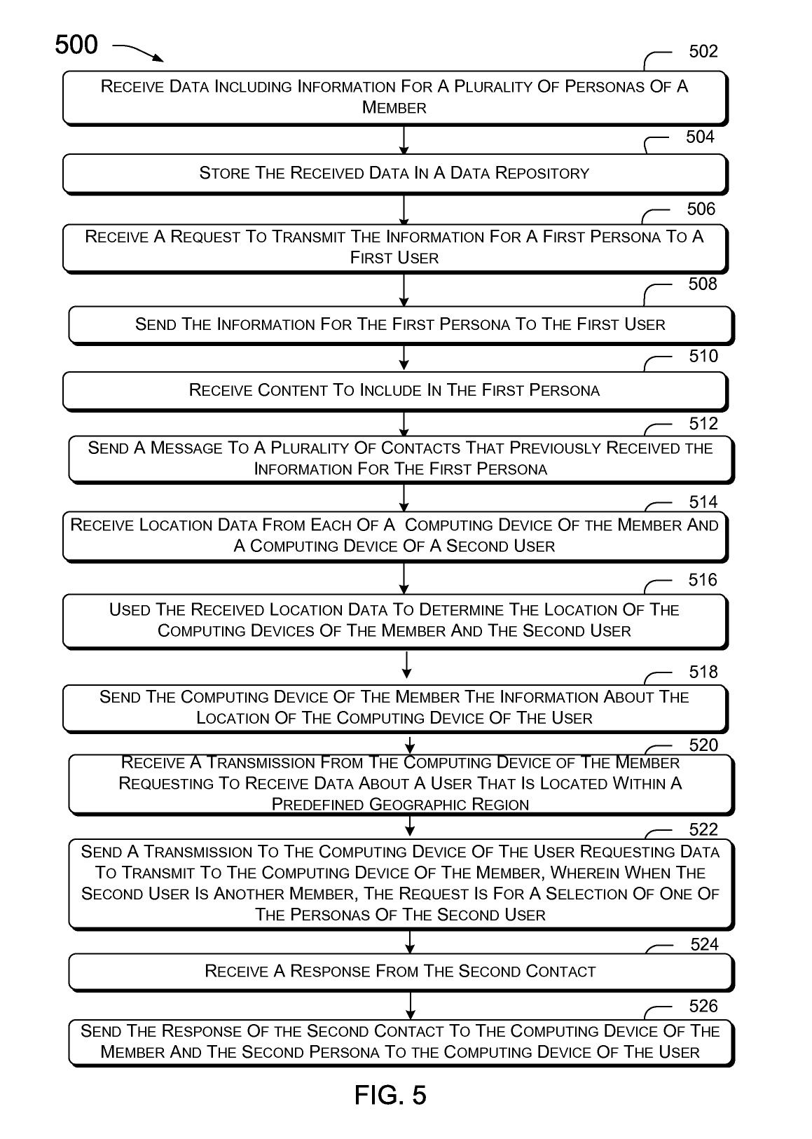

In FIG. 5, a flow chart summarizes an exemplary method 500 for managing information relevant to one or more Identities of a member and sharing the information with a user via system of FIG. 1 and/or FIG. 2. At a step 502, data for a plurality of Identities of a member is received. For example, the data in the member profile 310 of FIG. 3A is sent to the social network server 130. The member profile 310 includes data 311 for a plurality of Identities. In some embodiments, the Identities differ from one another in that they include different portions of the data 311 in the member profile 310. At step 504, the received data is stored in a data repository. For example, the social network server 130 stores the received data in the information 137.

In certain embodiments, the member sends a user a selected Identity of the member. At step 506, a request to transmit the information for a first Identity to a first user is received. For example, the social network server 130 receives a transmission from the computing device 110 of the member that includes a request to send member Identity 331 of FIG. 3A to an old high school friend having a known email address. At step 508, the information for the first Identity is sent to the first user. In the above example, the social network server 130 sends the information for Identity 331 in an email message addressed to the old high school friend. In certain embodiments, the computing device 150 of the user locally saves information received from the social network server 130. For example, the computing device 150 of the user receives information for the first Identity and saves the information in the computer readable medium 153. In this manner, when the computing device 150 of the user is not in communication with the social network server 130 via the communication fabric 140, the information for the first Identity is still accessible to the user. Alternatively, or in combination, the member's corresponding Identity, is stored in the information 137 of the social network server 130.

In certain embodiments, the content associated with an Identity is updated that is, in turn, sent to respective users or contacts of the member. At step 510, content is received for association with the first Identity. For example, the social network server 130 receives an updated contact information 312 for the member or a new blog entry 320 that is stored in the information 137 and association with the first Identity. At step 512, a message is sent to the contacts that previously received the information for the first Identity. For example, the social network server 130 forms transmissions including the updated contact information 312 for delivery to computing devices 150 of users that previously received the information for the first Identity. To illustrate, the member sends his high school friends, Mary Smith and Jim Swartz, the information in the first Identity, which included the member's old contact information. The member then updates his contact information that is associated with the first Identity of the member.

In certain embodiments, the content received in step 510 is automatically sent to each of the computing devices 150 of users that received the first Identity. After the social network server 130 receives the update address, both Mary's and Jim's respective computing devices 150 receive the member's updated contact information. In certain embodiments, the content received in step 510 is sent upon respective queries from the computing devices 150 of the users that received the first Identity or upon the member selecting users to receive the content.

As stated previously, in certain embodiments, a member is notified that a user having a computing device 150 is located within a proximate geographical region in a vicinity of the computing device 110 of the member. For example, at step 514, GPS data is received from each of a computing device 110 of the member and a computing device 150 of a user. At step 516, the respective GPS data is use to determine the location of the computing devices 110 and 150 within the geographic region. At step 518, the computing device 110 of the member receives a notice that the computing device 150 of the user is located in the proximate geographic region within a vicinity of the computing device 110. To illustrate, the member and a contact of the member Franks, both decide to attend a professional conference. When both the member and Franks are within a predetermined geographic regions, such as 10 meters from each other, the member receives a notice that Frank is located in his vicinity.

The user in the vicinity of the computing device 110 need not be in the contact list of the member for the member to receive information about the user. At step 520, a transmission is received from the computing device 110 of the member requesting to exchange data with a user that is located within a predefined geographic region. The social network server 130 determines if the user within the vicinity has a corresponding profile stored in the information 137, in which case, the user is another member. At step 522, a transmission is sent to the computing device 150 of the user in the geographic vicinity requesting data to transmit to the computing device 110 of the member. When the user is determined to be another member, the request sent to the computing device 150 of the user requests a selection of an Identity to send to the member requesting the data. For example, member Jones is in close proximity to user Smith. Member Jones requests information about user Smith. The social network server 130 determines whether Smith is a member by checking the information 137 for data about Smith. If Smith is a member, the social network server 130 sends a transmission to Smith's computing device 150 requesting that member Smith select from member Smith's Identities that are stored in the information 137 to send to member Jones. At step 524, the response to the request in step 522 is received. In the example above, Smith sends a selected Identity to the social network server 130. At step 526, the social network server 130 sends the response of step 524 to the computing device 110 of the member.

In certain embodiments, the user-member of the above example need not select an Identity to send to the member at step 522, rather the user-member has a preselected Default Identity that is freely shared with other users. The user-member sets up business rules that instruct the social network server 130 to freely share the information stored in association with the Default Identity of the user-member with other members (See FIG. 3B, Identity 321 (Default)). The social network server 130, in turn, sends the Default Identity to other members that request the respective information.

The schematic flow chart diagrams included are generally set forth as a logical flow-chart diagram (e.g., FIG. 5). As such, the depicted order and labeled steps are indicative of one embodiment of the presented method. In certain embodiments, other steps and methods are conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types are employed in the flow-chart diagrams, they are understood not to limit the scope of the corresponding method (e.g., FIG. 5). Indeed, some arrows or other connectors may be used to indicate only the logical flow of the method. For instance, an arrow indicates a waiting or monitoring period of unspecified duration between enumerated steps of the depicted method. Additionally, the order in which a particular method occurs may or may not strictly adhere to the order of the corresponding steps shown.

In certain embodiments, individual steps recited in FIG. 5 are combined, eliminated, or reordered.

In certain embodiments, Applicants' invention includes an article of manufacture comprising a platform for information management, such as computing device 110, 130, and/or 150, comprising computer readable program code, such as API 116, API 156, and/or Applicants' social network source code 136, residing in a non-transitory computer readable medium, such as computer readable medium 113, 133, and/or 153, where that computer readable program code can be executed by a processor, such as processor 112 (FIG. 1) and/or 132 (FIG. 1), and/or 152, to implement Applicants' social network source code.

In certain embodiments, Applicants' social network source code resides in a computer program product, where that computer program product comprises computer readable program code that can be executed by a computing device. In either case, in certain embodiments, the computer readable program code is encoded in a non-transitory computer readable medium comprising, for example, a magnetic information storage medium, an optical information storage medium, an electronic information storage medium, and the like. “Electronic storage media,” means, for example and without limitation, one or more devices, such as and without limitation, a PROM, EPROM, EEPROM, Flash PROM, compactflash, smartmedia, and the like.

Examples of computer readable program code include, but are not limited to, micro-code or micro-instructions, machine instructions, such as produced by a compiler, code used to produce a web service, and files containing higher-level instructions that are executed by a computer using an interpreter. For example, embodiments are be implemented using Java, C++, or other programming languages (e.g., object-oriented programming languages) and development tools. Additional examples of computer code include, but are not limited to, control signals, encrypted code, and compressed code.

While the preferred embodiments of the present invention have been illustrated in detail, it should be apparent that modifications and adaptations to those embodiments may occur to one skilled in the art without departing from the scope of the present invention as set forth herein.

We claim:

1. A method to create a member account in a social network, comprising:
downloading an application programming interface from a social network server;
creating a profile;
creating a plurality of Identities associated with said profile;
creating an different association for each Identity with one or more of a plurality of social network members and users, such that all contact with a first social network member is made using exclusively a first Identity, and such that all contact with a second social network member is made using exclusively a second Identity, wherein the first Identity differs from the second Identity;
uploading said profile, said plurality of Identities, and said associations of Identities, to said social network server.

2. The method of claim 1, further comprising uploading to said social network server a plurality of information fields, wherein one or more of said information fields are associated with each of said plurality of Identities.

3. The method of claim 2, further comprising:
creating a new information field in said profile;
automatically setting a privacy property for said new information field as Private and not associated with any of said plurality of Identities.

4. The method of claim 1, further comprising revising said permissions file to disallow access to said profile by a designated social network member or user.

5. The method of claim 1, further comprising designating one of said plurality of Identities as a Default Identity.

6. The method of claim 1, further comprising setting a privacy property for each of said plurality of Identities.

7. The method of claim 6, wherein:
said privacy levels are selected from the group consisting of default, shareable, and non-shareable;
a social network member having access to a shareable Identity may forward that Identity to other social network members; and
a social network member having access to a non-shareable Identity may not forward that Identity to other social network members.

8. The method of claim 1, further comprising:
uploading to said social network server a geographical location proximity;
determining a current geographical location;
uploading said current geographical location to said social network server;
receiving from said social network server information associated with an identified social network member, wherein said identified social network member is located within said geographical location proximity.

9. The method of claim 8, wherein said information comprises a member profile for said identified social network member.

10. The method of claim 9, wherein said information comprises a Default Identity associated with said identified social network member.

11. The method of claim 1, further comprising:
creating a permissions file allowing one or more social network members to access said profile;
uploading said permissions file to said social network server.

12. The method of claim 11, further comprising
creating and assigning a global unique identifier (“GUID”) to said profile;
wherein said GUID is associated with each of said plurality of Identities.

13. The method of claim 12, further comprising:
configuring a logical volume in a physical data storage medium;
associating said logical volume with said GUID;
encoding said profile, said plurality of Identities, and said information fields, in said logical volume.

14. The method of claim 13, wherein said physical data storage medium is disposed in said social network server.

15. The method of claim 13, wherein said physical data storage medium is disposed in a data storage library remote from, but in communication with, said social network server.

16. An article of manufacture comprising a non-transitory computer readable medium having computer readable program code encoded therein to create a member account in a social network, the computer readable program code comprising a series of computer readable program steps to effect:
downloading an application programming interface from a social network server;
creating a profile;
creating a plurality of Identities associated with said profile;
creating an different association for each Identity with one or more social network members and users, such that all contact with a first social network member is made using exclusively a first Identity, and such that all contact with a second social network member is made using exclusively a second Identity, wherein the first Identity differs from the second Identity;
uploading said profile, said plurality of Identities, and said associations of Identities, to said social network server.

17. The article of manufacture of claim 16, the computer readable program code further comprising a series of computer readable program steps to effect uploading to said social network server a plurality of information fields, wherein one or more of said information fields are associated with each of said plurality of Identities.

18. The article of manufacture of claim 17, the computer readable program code further comprising a series of computer readable program steps to effect:
creating a new information field in said profile;
automatically setting a privacy property for said new information field as Private and not associated with any of said plurality of Identities.

19. The article of manufacture of claim 16, the computer readable program code further comprising a series of computer readable program steps to effect revising said permissions file to disallow access to said profile by a designated social network member or user.

20. The article of manufacture of claim 16, the computer readable program code further comprising a series of computer readable program steps to effect designating one of said plurality of Identities as a Default Identity.

21. The article of manufacture of claim 16, the computer readable program code further comprising a series of computer readable program steps to effect setting a privacy property for each of said plurality of Identities.

22. The article of manufacture of claim 21, wherein:
said privacy levels are selected from the group consisting of default, shareable, and non-shareable;
a social network member having access to a shareable Identity may forward that Identity to other social network members; and
a social network member having access to a non-shareable Identity may not forward that Identity to other social network members.

23. The article of manufacture of claim 16, the computer readable program code further comprising a series of computer readable program steps to effect:
uploading to said social network server a geographical location proximity;
determining a current geographical location;
uploading said current geographical location to said social network server;
receiving from said social network server information associated with an identified social network member, wherein said identified social network member is located within said geographical location proximity.

24. The article of manufacture of claim 23, wherein said information comprises a member profile for said identified social network member.

25. The article of manufacture of claim 24, wherein said information comprises a Default Identity associated with said identified social network member.

26. The article of manufacture of claim 16, the computer readable program code further comprising a series of computer readable program steps to effect:
creating a permissions file allowing one or more social network members to access said profile;
uploading said permissions file to said social network server.

27. The article of manufacture of claim 26, the computer readable program code further comprising a series of computer readable program steps to effect:
creating and assigning a global unique identifier (“GUID”) to said profile;
wherein said GUID is associated with each of said plurality of Identities.

28. The article of manufacture of claim 27, the computer readable program code further comprising a series of computer readable program steps to effect:
configuring a logical volume in a physical data storage medium;
associating said logical volume with said GUID;
encoding said profile, said plurality of Identities, and said information fields, in said logical volume.

29. The article of manufacture of claim 28, wherein said physical data storage medium is disposed in said social network server.

30. The article of manufacture of claim 28, wherein said physical data storage medium is disposed in a data storage library remote from, but in communication with, said social network server.

31. A computer program product encoded in a non-transitory computer readable medium and usable with a programmable computer processor to create a member account in a social network, comprising:
computer readable program code which causes said programmable computer processor to download an application programming interface from a social network server;
computer readable program code which causes said programmable computer processor to create a profile;
computer readable program code which causes said programmable computer processor to create a plurality of Identities associated with said profile;
computer readable program code which causes said programmable computer processor to create an different association for each Identity with one or more social network members and users, such that all contact with a first social network member is made using exclusively a first Identity, and such that all contact with a second social network member is made using exclusively a second Identity, wherein the first Identity differs from the second Identity;
computer readable program code which causes said programmable computer processor to upload said profile, said plurality of Identities, and said associations of Identities, to said social network server.

32. The computer program product of claim 31, further comprising computer readable program code which causes said programmable computer processor to upload to said social network server a plurality of information fields, wherein one or more of said information fields are associated with one or more of said plurality of Identities.

33. The computer program product of claim 32, further comprising:
computer readable program code which causes said programmable computer processor to create a new information field in said profile;
computer readable program code which causes said programmable computer processor to automatically set a privacy property for said new information field as Private and not associated with any of said plurality of Identities.

34. The computer program product of claim 1, further comprising computer readable program code which causes said programmable computer processor to revising said permissions file to disallow access to said profile by a designated social network member.

35. The computer program product of claim 31, further comprising computer readable program code which causes said programmable computer processor to designate one of said plurality of Identities as a Default Identity.

36. The computer program product of claim 31, further comprising computer readable program code which causes said programmable computer processor to set a privacy property for each of said plurality of Identities.

37. The computer program product of claim 36, wherein:
said privacy levels are selected from the group consisting of default, shareable, and non-shareable;
a social network member having access to a shareable Identity may forward that Identity to other social network members; and
a social network member having access to a non-shareable Identity may not forward that Identity to other social network members.

38. The computer program product of claim 31, further comprising:
computer readable program code which causes said programmable computer processor to upload to said social network server a geographical location proximity;
computer readable program code which causes said programmable computer processor to determine a current geographical location;
computer readable program code which causes said programmable computer processor to upload said current geographical location to said social network server;
computer readable program code which causes said programmable computer processor to receive from said social network server information associated with an identified social network member, wherein said identified social network member is located within said geographical location proximity.

39. The computer program product of claim 38, wherein said information comprises a member profile for said identified social network member.

40. The computer program product of claim 39, wherein said information comprises a Default Identity associated with said identified social network member.

41. The computer program product of claim 31, further comprising:
computer readable program code which causes said programmable computer processor to create a permissions file allowing one or more social network members to access said profile;
computer readable program code which causes said programmable computer processor to uploading said permissions file to said social network server.

42. The computer program product of claim 41, further comprising
computer readable program code which causes said programmable computer processor to create and assign a global unique identifier (“GUID”) to said profile;
wherein said GUID is associated with each of said plurality of Identities.

43. The computer program product of claim 42, further comprising:
computer readable program code which causes said programmable computer processor to configure a logical volume in a physical data storage medium;
computer readable program code which causes said programmable computer processor to associate said logical volume with said GUID;
computer readable program code which causes said programmable computer processor to encode said profile, said plurality of Identities, and said information fields, in said logical volume.

44. The computer program product of claim 43, wherein said physical data storage medium is disposed in said social network server.

45. The computer program product of claim 43, wherein said physical data storage medium is disposed in a data storage library remote from, but in communication with, said social network server.
